(19) United States
(12) Patent Application Publication
(10) Pub. No.: US 2025/0356555 A1
(43) Pub. Date: Nov. 20, 2025

(54) IMAGE PROCESSING METHOD AND APPARATUS, DEVICE, COMPUTER-READABLE STORAGE MEDIUM, AND PRODUCT

(71) Applicant: Beijing Zitiao Network Technology Co., Ltd., Beijing (CN)

(72) Inventor: Qianqian WANG, Beijing (CN)

(21) Appl. No.: 19/205,630

(22) Filed: May 12, 2025

(30) Foreign Application Priority Data
May 16, 2024 (CN) 202410612440.6

(51) Int. Cl. G06T 11/60

(52) U.S. Cl. CPC G06T 11/60

(57) ABSTRACT

Embodiments of the present disclosure provide an image processing method, an apparatus, a device, a computer-readable storage medium, and a product. The method includes: obtaining an image to be processed and an image expansion text; performing a padding operation on the image to be processed based on a preset background to obtain a padded image; inputting the padded image and the image expansion text to a preset target model, the target model being obtained after a preset model to be trained is iteratively trained based on a preset training dataset, a training data pair including an original image, an image expansion description text, a random mask, a masked image, and a cropped image obtained through cropping based on the original image and the random mask; and performing an image expansion operation on the image to be processed based on a predicted noise that is output by the target model.

### CROSS-REFERENCE TO RELATED APPLICATION(S)

This application claims priority to Chinese Application No. 202410612440.6 filed on May 16, 2024, the disclosure of which is incorporated herein by reference in its entirety.

### FIELD

Embodiments of the present disclosure relate to a field of image processing technologies, and in particular, to an image processing method and apparatus, a device, a computer-readable storage medium, and a product.

### BACKGROUND

With the continuous development of image processing technologies, users can perform an expansion operation on a selected original image according to actual needs, generating an expanded region around the original image to obtain an image expansion result with enriched content.

### SUMMARY

Embodiments of the present disclosure provide an image processing method and apparatus, a device, a computer-readable storage medium, and a product, to solve a technical problem of a low degree of matching between an expanded region generated by the existing image expansion solutions and an original image.

According to a first aspect, an embodiment of the present disclosure provides an image processing method. The method includes:
obtaining an image to be processed and an image expansion text;
performing a padding operation on the image to be processed based on a preset background to obtain a padded image, where a display size of the preset background is greater than a display size of the image to be processed;
inputting the padded image and the image expansion text to a preset target model, the target model being obtained after the preset model to be trained is iteratively trained based on the preset training dataset, where the training dataset includes a plurality of training data pairs, and the training data pair includes an original image, an image expansion description text, a random mask, a masked image obtained by masking the original image based on the random mask, and a cropped image obtained through cropping based on the original image and the random mask; and
obtaining a predicted noise corresponding to the padded image, which is output by the target model, and performing an image expansion operation on the image to be processed based on the predicted noise.

According to a second aspect, an embodiment of the present disclosure provides an image processing apparatus. The apparatus includes:
an obtaining module configured to obtain an image to be processed and an image expansion text; a padding module configured to perform a padding operation on the image to be processed based on a preset background to obtain a padded image, where a display size of the preset background is greater than a display size of the image to be processed;
a processing module configured to input the padded image and the image expansion text to a preset target model, the target model being obtained after a preset model to be trained is iteratively trained based on a preset training dataset, where the training dataset includes a plurality of training data pairs, and the training data pair includes an original image, an image expansion description text, a random mask, a masked image obtained by masking the original image based on the random mask, and a cropped image obtained through cropping based on the original image and the random mask; and
an image expansion module configured to obtain a predicted noise corresponding to the padded image, which is output by the target model, and perform an image expansion operation on the image to be processed based on the predicted noise.

According to a third aspect, an embodiment of the present disclosure provides an electronic device. The electronic device includes: a processor and a memory, where the memory stores computer-executable instructions; and the processor executes the computer-executable instructions stored in the memory to cause the processor to perform the image processing method according to the first aspect and various possible designs of the first aspect.

According to a fourth aspect, an embodiment of the present disclosure provides a computer-readable storage medium. The computer-readable storage medium stores computer-executable instructions that, when executed by a processor, implement the image processing method according to the first aspect and various possible designs of the first aspect.

According to a fifth aspect, an embodiment of the present disclosure provides a computer program product including a computer program that, when executed by a processor, implements the image processing method according to the first aspect and various possible designs of the first aspect.

### BRIEF DESCRIPTION OF THE DRAWINGS

In order to describe the technical solutions in embodiments of the present disclosure or in the prior art more clearly, the accompanying drawings for describing the embodiments or the prior art will be briefly described below. Apparently, the accompanying drawings in the description below show some embodiments of the present disclosure, and those of ordinary skill in the art may still derive other accompanying drawings from these accompanying drawings without creative efforts.

FIG. 1 is a schematic flowchart of an image processing method according to an embodiment of the present disclosure;

FIG. 2 is a schematic flowchart of an image processing method according to another embodiment of the present disclosure;

FIG. 3 is a schematic flowchart of an image processing method according to another embodiment of the present disclosure;

FIG. 4 is a schematic flowchart of an image processing method according to another embodiment of the present disclosure;

FIG. 5 is a schematic diagram of a model training scenario according to an embodiment of the present disclosure;

FIG. 6 is a schematic diagram of a structure of an image processing apparatus according to an embodiment of the present disclosure; and

FIG. 7 is a schematic structural diagram of an electronic device according to an embodiment of the present disclosure.

### DETAILED DESCRIPTION OF EMBODIMENTS

In order to make the objectives, technical solutions, and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All other embodiments obtained by those of ordinary skill in the art based on the embodiments of the present disclosure without any creative effort shall fall within the scope of protection of the present disclosure.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

The expanded region generated by the existing image expansion methods has a low degree of matching with the original image. For example, the colors of the expanded region are not in harmony with those of the original image, or the style of the expanded region is inconsistent with that of the original image, resulting in poor quality of the generated image expansion result.

To solve the technical problem of a low degree of matching between an expanded region generated by the existing image expansion solutions and an original image, the present disclosure provides an image processing method and apparatus, a device, a computer-readable storage medium, and a product.

It should be noted that the image processing method and apparatus, the device, the computer-readable storage medium, and the product, which are provided in the present disclosure, can be applied to any image expansion scenario.

The expanded content generated by the current image expansion solutions often has a low degree of matching with the original image input by a user. For example, in an image expansion result, there may be a color difference between the original image and the expanded content, or the style of the original image is inconsistent with that of the expanded content.

In the process of addressing the above technical problems, the inventors have found through research that in order to improve the consistency between the generated expanded content and the image to be processed, and to reduce the color difference at the boundary of the image to be processed, a cropped image can be introduced during the training of the model to be trained. The cropped image is obtained by cropping the original image based on a random mask. By introducing the cropped image, it is possible to provide enriched content and color information based on the known region, thereby enabling the generation of expanded content that better matches the original image.

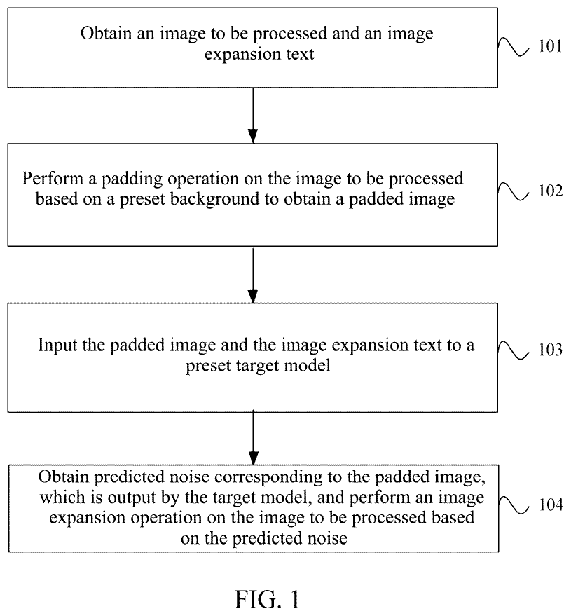

FIG. 1 is a schematic flowchart of an image processing method according to an embodiment of the present disclosure. As shown in FIG. 1, the method includes:

Step 101: Obtain an image to be processed and an image expansion text.

An execution body of this embodiment is an image processing apparatus. The image processing apparatus may be coupled to a terminal device, enabling an image expansion operation to be performed based on the image to be processed and the image expansion text, which are determined by a user on the terminal device. Alternatively, the image processing apparatus may be coupled to a server, such that the image processing apparatus can obtain the image to be processed and the image expansion text, which are determined by the user on the terminal device, perform the image expansion operation through using a preset target model based on the image to be processed and the image expansion text, and feed a target image generated through image expansion back to the terminal device.

In this implementation, in order to implement the image expansion operation, the image to be processed and the image expansion text may be obtained. The image to be processed may be obtained in real time by the user, or may be uploaded according to a preset storage path, which is not limited in the present disclosure. The image expansion text is used for describing an image expansion part that the user wants to generate, so as to generate an image expansion result that better meets personalized needs of the user.

Step 102: Perform a padding operation on the image to be processed based on a preset background to obtain a padded image, where a display size of the preset background is greater than a display size of the image to be processed.

In this implementation, after the image to be processed is obtained, in order to implement the image expansion operation on the image to be processed to obtain an image with a larger size and enriched content, the padding operation may be performed on the image to be processed based on the preset background to obtain the padded image. The preset background may be a solid-colored background, for example, a black background. The size of the preset background is greater than the size of the image to be processed, where the size of the preset background may be preset, or may be set according to an actual need of the user, which is not limited in the present disclosure.

Step 103: Input the padded image and the image expansion text to a preset target model, the target model being obtained after a preset model to be trained is trained iteratively based on a preset training dataset, where the training dataset includes a plurality of training data pairs, and the training data pair includes an original image, an image expansion description text, a random mask, a masked image obtained by masking the original image based on the random mask, and a cropped image obtained through cropping based on the original image and the random mask; and

In this implementation, the padded image and the image expansion text may be input to the preset target model, the target model is obtained after the preset model to be trained is iteratively trained based on the preset training dataset, where the training dataset includes the plurality of training data pairs, and the training data pair includes the original image, the image expansion description text, the random mask, the masked image obtained by masking the original image based on the random mask, and the cropped image obtained through cropping based on the original image and the random mask.

Optionally, the model to be trained may be a diffusion model. Alternatively, the model to be trained may be any model that can implement noise recognition. This is not limited in the present disclosure.

Since the cropped image obtained by cropping the original image based on the random mask is introduced to the target model during training, so that the target model can learn more information about colors and content in the original image, and can more accurately predict noise corresponding to the padded image. Then, a predicted noise output by the target model is obtained, and the image expansion operation is performed on the image to be processed based on the predicted noise.

Step 104: Obtain a predicted noise corresponding to the padded image, which is output by the target model, and perform an image expansion operation on the image to be processed based on the predicted noise.

In this implementation, the target model can perform a prediction operation on noise in the padded image to obtain the predicted noise corresponding to the padded image. Thus, after the predicted noise is obtained and the predicted noise in the padded image is removed, the image expansion result can be obtained, and the image expansion operation on the image to be processed is implemented.

According to the image processing method provided in this embodiment, the target model is used to predict the noise in the padded image, and a denoising operation is performed on the padded image based on the predicted noise to obtain the target image after image expansion. Since the cropped image obtained by cropping the original image based on the random mask is introduced to the target model during training, enabling the target model to learn more information about colors and content in the original image. Further, the consistency between the expanded content in the generated target image and the image to be processed is high, and a color difference at the boundary of the image to be processed is avoided.

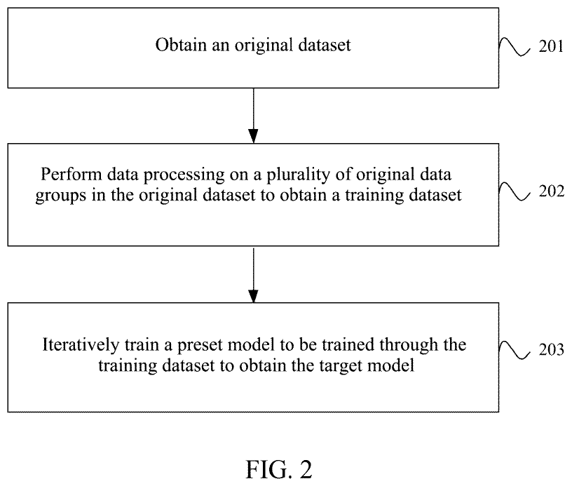

FIG. 2 is a schematic flowchart of an image processing method according to another embodiment of the present disclosure. On the basis of any one of the above embodiments, as shown in FIG. 2, before step 103, the method further includes the steps as follows.

Step 201: Obtain an original dataset, where the original dataset includes original data groups, and the original data group includes an original image, an image expansion description text, and a random mask.

An execution body of this embodiment is an image processing apparatus. The image processing apparatus may be coupled to a server. The server can be communicatively connected to a preset data server, thereby enabling obtaining of a training dataset from the data server to iteratively train a preset model to be trained based on the training dataset. The model to be trained may be a diffusion model.

In a possible implementation, the image processing apparatus for obtaining the target model through training may be coupled to the same device as the image processing apparatus for performing the image expansion operation. The device may be a server or a terminal device, which is not limited in the present disclosure. Thus, the training operation for the target model may be completed in the same device, and the image expansion operation may be performed based on the target model.

In this implementation, in order to implement the training operation on the model to be trained, the original dataset may be obtained. The original dataset includes the plurality of original data groups, the original data group includes the original image, the random mask, and the image expansion description text. A display size and a display position of the random mask may be random, or may be set by a user according to an actual need, which is not limited in the present disclosure. The image expansion description text is used for describing the expanded content, to generate a more accurate image expansion result.

Step 202: Perform data processing on a plurality of original data groups in the original dataset to obtain a training dataset.

In this implementation, after the original dataset is obtained, data processing may further be performed on data in the original dataset to obtain the training dataset for training the model to be trained.

Optionally, a masking operation may be performed on the original image based on the random mask to obtain a masked image. In the random mask, coordinates corresponding to a part that needs to be displayed may be 0, and coordinates of a part that needs to be masked may be 1. In this way, after the random mask is applied to the original image, the masking operation on the partial region can be implemented.

Further, in order to enable the model to be trained to learn more information about colors and content in the original image, a cropping operation may be further performed on the original image based on the random mask to obtain a cropped image. The cropped image is introduced during training.

Step 203: Iteratively train a preset model to be trained through the training dataset to obtain the target model.

In this implementation, after the original image, the random mask, the image expansion description text, the masked image, and the cropped image are obtained separately, an iterative training operation may be performed on the preset model to be trained based on the original image, the random mask, the image expansion description text, the masked image, and the cropped image, until the model to be trained satisfies a preset convergence condition, so as to obtain the trained target model. The preset convergence condition may be that a loss value of the model to be trained is less than a preset loss value threshold. Alternatively, a preset convergence condition may be that a difference between loss values of the model to be trained in two iterations of training is less than a preset difference threshold. Alternatively, the preset convergence condition may also be that a number of iterations of training of the model to be trained reaches a preset number threshold. Alternatively, the preset convergence condition may also be that a duration of the iterative training of the model to be trained reaches a preset duration threshold. This is not limited in the present disclosure.

Optionally, in order to implement the iterative training operation on the model to be trained, a preset noise may further be input to the model to be trained, so that the loss value of the model to be trained may be subsequently determined based on a prediction noise output by the model to be trained and the preset noise. Then, it can be determined whether the model to be trained satisfies the preset convergence condition based on the loss value.

After the training of the model to be trained is completed and the target model is obtained, the user can determine the image to be processed and the image expansion text, and input the image to be processed and the image expansion text to the target model to obtain the predicted noise output by the target model. Then, the image expansion operation can be performed based on the predicted noise.

According to the image processing method provided in the embodiments, during the training of the model to be trained, the cropped image obtained by cropping the original image based on the random mask is introduced, so that the model to be trained can learn more information about colors and content in the original image. Thus, performing the image expansion operation based on content output by the model to be trained may enable the consistency between generated expanded content and the image to be processed to be greatly improved, and a color difference at the boundary of the image to be processed to be reduced.

Optionally, on the basis of any one of the above embodiments, step 102 includes: determining a target region in the original image that matches the random mask, and performing a masking operation on a region in the original image other than the target region to obtain a masked image;
performing a cropping operation on the target region to obtain a cropped image;
determining the original image, the random mask, the image expansion description text, the cropped image, and the masked image as a training data pair; and
constructing the training dataset based on a plurality of training data pairs corresponding to the plurality of original data groups.

In this embodiment, after the original image and the random mask are obtained, the masking operation may be performed on the original image based on the random mask to obtain the masked image. Therefore, the target region in the original image that matches the random mask may be determined. The target region may be random, or may be set by a user according to an actual need, which is not limited in the present disclosure.

In the random mask, coordinates corresponding to the target region may be 0, and coordinates of a part other than the target region, which needs to be masked, may be 1. In this way, after the random mask is applied to the original image, content of the target region can be displayed normally, and content of the non-target region can be masked.

Further, after the target region is determined, the cropping operation may be performed on the target region to obtain the cropped image.

According to the image processing method provided in this embodiment, masking the original image based on the random mask can enable the model to be trained to predict noise of a masked part during training. Moreover, performing the cropping operation on the original image based on the random mask can enable the model to be trained to learn more information about colors and content in the original image, thereby improving the degree of association between the expanded content and the original image.

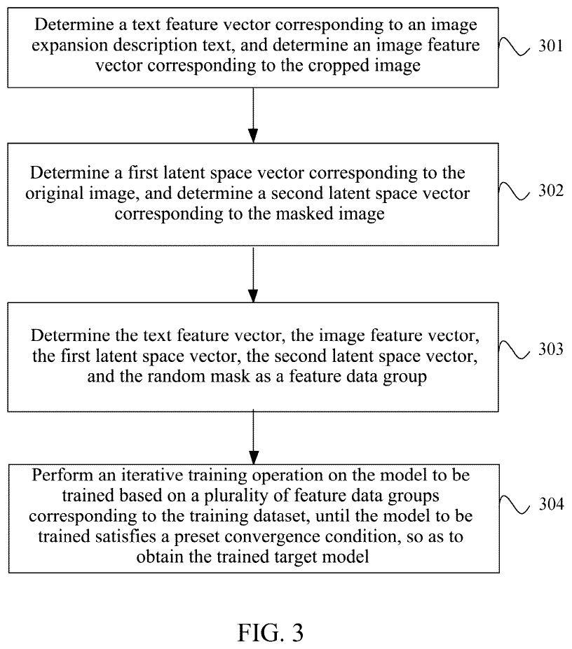

FIG. 3 is a schematic flowchart of an image processing method according to another embodiment of the present disclosure. On the basis of any one of the above embodiments, as shown in FIG. 3, step 203 includes:
step 301: determining a text feature vector corresponding to the image expansion description text, and determining an image feature vector corresponding to the cropped image;
step 302: determining a first latent space vector corresponding to the original image, and determining a second latent space vector corresponding to the masked image;
step 303: determining the text feature vector, the image feature vector, the first latent space vector, the second latent space vector, and the random mask as a feature data group; and
step 304: performing an iterative training operation on the model to be trained based on a plurality of feature data groups corresponding to the training dataset, until the model to be trained satisfies a preset convergence condition, so as to obtain the trained target model.

In this embodiment, after the original image, the random mask, the cropped image, and the masked image are obtained separately, a feature extraction operation may be performed on the original image, the random mask, the cropped image, and the masked image, to implement the training operation on the model to be trained.

Optionally, the text feature vector corresponding to the image expansion description text may be determined, and the image feature vector corresponding to the cropped image may be determined. the feature extraction operation on the cropped image may be implemented by using any image feature extraction algorithm, and the feature extraction operation on the image expansion description text may be implemented by using any text feature extraction algorithm, which are not limited in the present disclosure.

Further, the first latent space vector corresponding to the original image may be determined, and the second latent space vector corresponding to the masked image may be determined. The first latent space vector and the second latent space vector may be determined by using a VAE encoder.

In order to implement the iterative training of the model to be trained, a preset noise may be further determined. The text feature vector, the image feature vector, the first latent space vector, the second latent space vector, and the random mask are determined as a feature data group. The iterative training operation is performed on the model to be trained based on the plurality of feature data groups corresponding to the training dataset, until the model to be trained satisfies the preset convergence condition, so as to obtain the trained target model.

According to the image processing method provided in this embodiment, feature vector extraction is performed on the original image, the cropped image, the masked image, and the image expansion description text, so that the feature data group can be constructed based on the text feature vector, the image feature vector, the first latent space vector, the second latent space vector, and the random mask. The iterative training operation is performed on the model to be trained based on the plurality of feature data groups corresponding to the training dataset, so that the model to be trained can predict noise of a masked part. On this basis, the degree of association between expanded content and the original image is improved, and a color difference at the edges of the original image is avoided.

Optionally, on the basis of any one of the above embodiments, step 301 includes: extracting the image feature vector corresponding to the cropped image based on a preset multi-modal pre-trained neural network and/or a preset large vision model.

In this embodiment, an image feature vector extraction operation on the cropped image may be implemented based on the preset multi-modal pre-trained neural network. Alternatively, an image feature vector extraction operation on the cropped image may be implemented based on the preset large vision model. Alternatively, an image feature vector extraction operation on the cropped image may also be implemented jointly based on the preset multi-modal pre-trained neural network and the preset large vision model, to improve the comprehensiveness and accuracy of the image feature vector. This is not limited in the present disclosure.

According to the image processing method provided in this embodiment, the image feature vector corresponding to the cropped image is extracted based on the preset multi-modal pre-trained neural network and/or the preset large vision model, so that the image feature vector extraction operation can be implemented quickly and accurately.

Further, on the basis of any one of the above embodiments, after step 201, the method further includes:
calculating cross-attention information based on the text feature vector and the image feature vector; and
determining the cross-attention information, the first latent space vector, the second latent space vector, and the random mask as a training data group.

In this embodiment, cross-attention fusion establishes connections between different modules through an attention mechanism, to promote information exchange and fusion, thereby improving the capability of the model to be trained to process complex tasks. Therefore, in order to further improve the processing precision of the model to be trained and enable the model to be trained to better learn content of the original image and the image expansion description text, after the text feature vector and the image feature vector are calculated separately, the cross-attention information can be calculated based on the text feature vector and the image feature vector. The calculation of the cross-attention information may be implemented by using any cross-attention feature fusion method, which is not limited in the present disclosure. Then, an iterative training operation may be performed on the model to be trained based on first latent space vectors, second latent space vectors, cross-attention information, random masks, and the preset noise, which are associated with a plurality of training data pairs.

According to the image processing method provided in this embodiment, the cross-attention information is calculated based on the text feature vector and the image feature vector, so that in the model training process, exchange and integration of text feature information and image feature information are promoted, and thus, expanded content that better fits the image expansion description text can be generated.

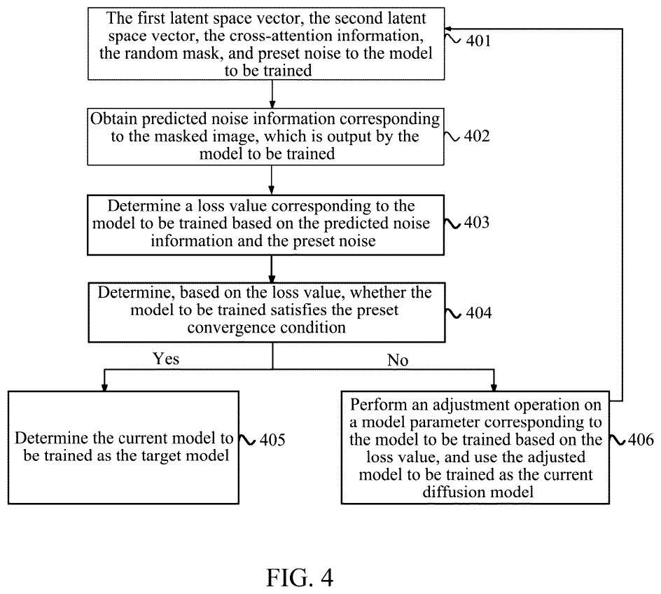

FIG. 4 is a schematic flowchart of an image processing method according to another embodiment of the present disclosure. On the basis of any one of the above embodiments, as shown in FIG. 4, step 304 includes:
step 401: inputting the first latent space vector, the second latent space vector, the cross-attention information, the random mask, and the preset noise to the model to be trained;
step 402: obtaining predicted noise information corresponding to the masked image, which is output by the model to be trained;
step 403: determining a loss value corresponding to the model to be trained based on the predicted noise information and the preset noise;
step 404: determining, based on the loss value, whether the model to be trained satisfies the preset convergence condition;
step 405: if yes, determining the current model to be trained as the target model; and
step 406: if no, performing an adjustment operation on a model parameter corresponding to the model to be trained based on the loss value, using the adjusted model to be trained as the current model to be trained, and returning to the step of inputting the first latent space vector, the second latent space vector, the cross-attention information, the random mask, and the preset noise to the model to be trained, until the model to be trained satisfies the convergence condition, so as to obtain the target model.

In this embodiment, after the first latent space vector, the second latent space vector, the cross-attention information, the random mask, and the preset noise are obtained separately, the first latent space vector, the second latent space vector, the cross-attention information, the random mask, and the preset noise may be input to the preset model to be trained. The model to be trained may predict noise of a masked part in the masked image.

Further, the predicted noise information output by the model to be trained may be obtained. Since the preset noise is added to the second latent space vector before the second latent space vector is input to the model to be trained, the loss value corresponding to the model to be trained can be determined based on the predicted noise information and the preset noise. The loss value corresponding to the model to be trained may be determined by using any algorithm that can determine a loss value, which is not limited in the present disclosure.

After the loss value corresponding to the model to be trained is determined, it may be determined, based on the loss value and the preset convergence condition, whether the model to be trained converges currently. If yes, the current model to be trained may be determined as the target model, and subsequently, the image expansion operation may be performed based on the target model.

Otherwise, the parameter adjustment operation may be performed on the model to be trained based on the loss value. The parameters of the model to be trained can be adjusted by means of backward gradient adjustment, which is not limited in the present disclosure. After the adjustment, the adjusted model to be trained may be used as the current model to be trained, and the method returns to the step of inputting the first latent space vector, the second latent space vector, the cross-attention information, the random mask, and the preset noise to the model to be trained, until the model to be trained satisfies the convergence condition, so as to obtain the target model.

Optionally, on the basis of any one of the above embodiments, step 304 includes:
determining whether the loss value is less than a preset loss value threshold, or
calculating a difference between a loss value corresponding to a current iteration of training and a loss value corresponding to a previous iteration of training; and
determining whether the difference is less than a preset difference threshold.

In this embodiment, the preset convergence condition may be that the loss value of the model to be trained is less than the preset loss value threshold. Therefore, after the loss value corresponding to the model to be trained is determined, the loss value may be compared with the preset loss value threshold, to determine whether the model to be trained converges.

In a possible implementation, the preset convergence condition may be that a difference between loss values corresponding to two iterations of training is less than the preset difference threshold. Therefore, after the loss value corresponding to the model to be trained is determined, the difference between the loss value corresponding to the current iteration of training and the loss value corresponding to the previous iteration of training may be calculated. It is determined whether the difference is less than the preset difference threshold, to determine whether the model to be trained converges.

In a possible implementation, the preset convergence condition may alternatively be that a number of iterations of training reaches a preset threshold (for example, the number of iterations reaches 100,000 or 200,000), a duration of the iterative training reaches a preset threshold, etc., which is not limited in the present disclosure.

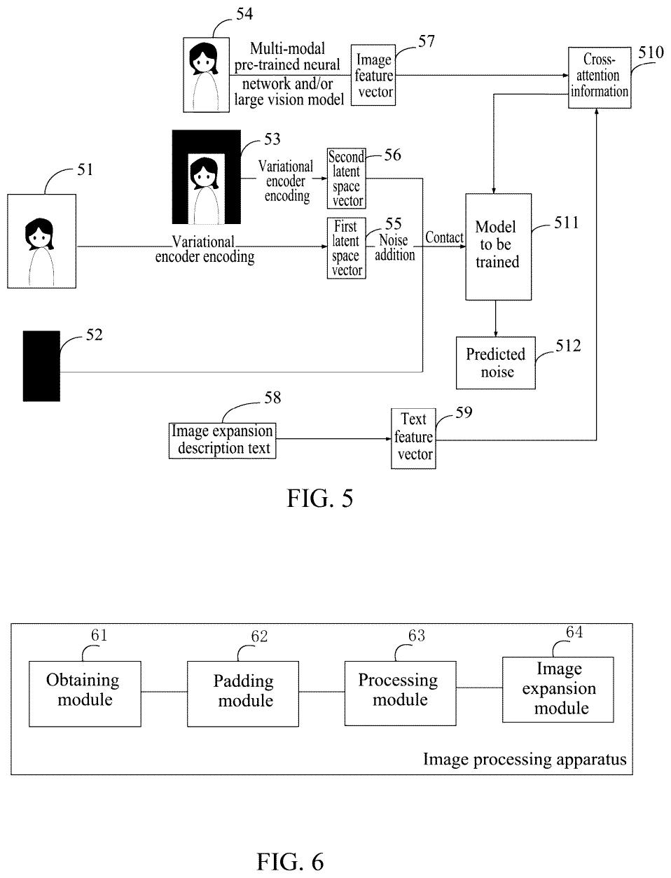

FIG. 5 is a schematic diagram of a model training scenario according to an embodiment of the present disclosure. As shown in FIG. 5, after an original image 51 and a random mask 52 are obtained, a masking operation may be performed on the original image 51 based on the random mask 52, to obtain a masked image 53. In addition, a cropping operation may be further performed on the original image 51 based on the random mask 52 to obtain a cropped image 54. A first latent space vector 55 corresponding to the original image 51 is determined, and a second latent space vector 56 corresponding to the masked image 53 is determined. A preset noise is added to the second latent space vector 56. An image feature vector 57 corresponding to the cropped image 54 is calculated, a text feature vector 59 corresponding to an image expansion description text 58 that is determined by a user is calculated, and then, cross-attention information 510 is calculated based on the image feature vector 57 and the text feature vector 59. The first latent space vector 55, the second latent space vector 56, the random mask 52, and the cross-attention information 510 are jointly input to a preset model 511 to be trained to obtain the predicted noise 512, which is output by the model 511 to be trained.

According to the image processing method provided in this embodiment, the convergence condition is set in advance, so that iterative training on the model to be trained can be performed based on the loss value corresponding to the model to be trained and the convergence condition, thereby improving the processing precision of the model to be trained.

Further, on the basis of any one of the above embodiments, step 104 includes: performing a denoising operation on the padded image based on the predicted noise, and determining the denoised padded image as a target image after image expansion.

In this embodiment, after the predicted noise corresponding to the padded image is predicted through the target model, the denoising operation may be performed on the padded image based on the predicted noise to obtain the target image after image expansion. The denoising operation on the padded image may be implemented by using any denoising method, which is not limited in the present disclosure.

According to the image processing method provided in this embodiment, the target model is used to predict the noise in the padded image, and the denoising operation is performed on the padded image based on the predicted noise to obtain the target image after image expansion. Since the cropped image obtained by cropping the original image based on the random mask is introduced to the target model during training, the target model can learn more information about colors and content in the original image. Further, the consistency between the expanded content in the generated target image and the image to be processed is high, and a color difference at the boundary of the image to be processed is avoided.

FIG. 6 is a schematic diagram of a structure of an image processing apparatus according to an embodiment of the present disclosure. As shown in FIG. 6, the apparatus includes: an obtaining module 61, a padding module 62, a processing module 63, and an image expansion module 64. The obtaining module 61 is configured to obtain an image to be processed and an image expansion text. The padding module 62 is configured to perform a padding operation on the image to be processed based on a preset background to obtain a padded image, where a display size of the preset background is greater than a display size of the image to be processed. The processing module 63 is configured to input the padded image and the image expansion text to a preset target model, the target model being obtained after a preset model to be trained is iteratively trained on a preset training dataset, where the training dataset includes a plurality of training data pairs, and the training data pair includes an original image, an image expansion description text, a random mask, a masked image obtained by masking the original image based on the random mask, and a cropped image obtained through cropping based on the original image and the random mask. The image expansion module 64 is configured to obtain the predicted noise corresponding to the padded image, which is output by the target model, and perform an image expansion operation on the image to be processed based on the predicted noise.

Further, on the basis of any one of the above embodiments, the apparatus includes: an obtaining module configured to obtain an original dataset, where the original dataset includes original data groups, and the original data group includes an original image, an image expansion description text, and a random mask; a processing module configured to perform data processing on a plurality of original data groups in the original dataset to obtain a training dataset; and a training module configured to iteratively train a preset model to be trained through the training dataset to obtain the target model.

Further, on the basis of any one of the above embodiments, the processing module is configured to: determine a target region in the original image that matches the random mask, and perform a masking operation on a region in the original image other than the target region to obtain a masked image; perform a cropping operation on the target region to obtain a cropped image; determine the original image, the random mask, the image expansion description text, the cropped image, and the masked image as a training data pair; and construct the training dataset based on a plurality of training data pairs corresponding to the plurality of original data groups.

Further, on the basis of any one of the above embodiments, the training module is configured to: determine a text feature vector corresponding to the image expansion description text, and determine an image feature vector corresponding to the cropped image; determine a first latent space vector corresponding to the original image, and determine a second latent space vector corresponding to the masked image; determine the text feature vector, the image feature vector, the first latent space vector, the second latent space vector, and the random mask as a feature data group; and perform an iterative training operation on the model to be trained based on a plurality of feature data groups corresponding to the training dataset, until the model to be trained satisfies a preset convergence condition, so as to obtain the trained target model.

Further, on the basis of any one of the above embodiments, the apparatus further includes: a calculation module configured to calculate cross-attention information based on the text feature vector and the image feature vector; and a determining module configured to determine the cross-attention information, the first latent space vector, the second latent space vector, and the random mask as a training data group.

Further, on the basis of any one of the above embodiments, the training module is configured to: input the first latent space vector, the second latent space vector, the cross-attention information, the random mask, and the preset noise to the model to be trained; obtain predicted noise information corresponding to the masked image, which is output by the model to be trained; determine a loss value corresponding to the model to be trained based on the predicted noise information and the preset noise; determine, based on the loss value, whether the model to be trained satisfies the preset convergence condition; and if yes, determine the current model to be trained as the target model, or if no, perform an adjustment operation on a model parameter corresponding to the model to be trained based on the loss value, use the adjusted model to be trained as the current model to be trained, and return to the step of inputting the first latent space vector, the second latent space vector, the cross-attention information, the random mask, and the preset noise to the model to be trained, until the model to be trained satisfies the convergence condition, so as to obtain the target model.

Further, on the basis of any one of the above embodiments, the training module is configured to: determine whether the loss value is less than a preset loss value threshold; or calculate a difference between a loss value corresponding to a current iteration of training and a loss value corresponding to a previous iteration of training; and determine whether the difference is less than a preset difference threshold.

Further, on the basis of any one of the above embodiments, the processing module is configured to extract the image feature vector corresponding to the cropped image based on a preset multi-modal pre-trained neural network and/or a preset large vision model.

Further, on the basis of any one of the above embodiments, the image expansion module is configured to perform a denoising operation on the padded image based on the predicted noise, and determine the denoised padded image as a target image after image expansion.

The apparatus provided in this embodiment may be configured to perform the technical solutions of the above method embodiments. The implementation principle and technical effects thereof are similar, and are not described herein again in this embodiment.

In order to implement the above embodiments, an embodiment of the present disclosure further provides a non-transitory computer-readable storage medium storing computer-executable instructions that, when executed by a processor, implement the image processing method according to any one of the above embodiments.

In order to implement the above embodiments, an embodiment of the present disclosure further provides a computer program product including a computer program that, when executed by a processor, implements the image processing method according to any one of the above embodiments.

In order to implement the above embodiments, an embodiment of the present disclosure further provides an electronic device. The electronic device includes: a processor and a memory, where the memory stores computer-executable instructions; and the processor executes the computer-executable instructions stored in the memory, to cause the processor to perform the image processing method according to any one of the above embodiments.

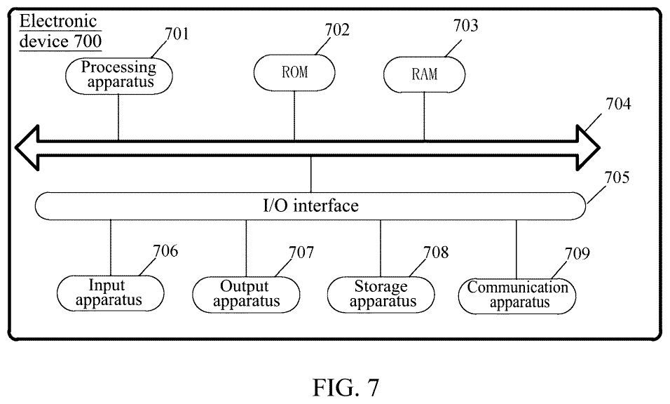

FIG. 7 is a schematic diagram of a structure of an electronic device according to an embodiment of the present disclosure. The electronic device 700 may be a terminal device or a server. The terminal device may include, but is not limited to, a mobile terminal such as a mobile phone, a notebook computer, a digital broadcast receiver, a personal digital assistant (PDA), a tablet computer (portable Android device, PAD), a portable media player (PMP), and a vehicle-mounted terminal (such as a vehicle navigation terminal), and a fixed terminal such as a digital TV and a desktop computer. The electronic device shown in FIG. 7 is merely an example, and shall not impose any limitation on the function and scope of use of the embodiments of the present disclosure.

As shown in FIG. 7, the electronic device 700 may include a processing apparatus (e.g., a central processing unit or a graphics processing unit) 701 that may perform a variety of appropriate actions and processing in accordance with a program stored in a read-only memory (ROM) 702 or a program loaded from a storage apparatus 708 into a random access memory (RAM) 703. The RAM 703 further stores various programs and data required for the operation of the electronic device 700. The processing apparatus 701, the ROM 702, and the RAM 703 are connected to each other via a bus 704. An input/output (I/O) interface 705 is also connected to a bus 704.

Generally, the following apparatuses may be connected to the I/O interface 705: an input apparatus 706 including, for example, a touchscreen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a tape and a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded and installed from a network through the communication apparatus 709, or installed from the storage apparatus 708, or installed from the ROM 702. When the computer program is executed by the processing apparatus 701, the above-mentioned functions defined in the methods of the embodiments of the present application are executed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the method shown in the above embodiments.

Computer program code for performing operations of the present disclosure can be written in one or more programming languages or a combination thereof, where the programming languages include object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. When a remote computer is involved, the remote computer may be connected to a user computer through any type of network, including a local area network (LAN) or a wide area network (WAN), or may be connected to an external computer (for example, connected by using an Internet service provider through the Internet).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. An image processing method, comprising:
obtaining an image to be processed and an image expansion text;
performing a padding operation on the image to be processed based on a preset background to obtain a padded image, wherein a display size of the preset background is greater than a display size of the image to be processed;
inputting the padded image and the image expansion text to a preset target model, wherein the target model is obtained after a preset model to be trained is iteratively trained based on a preset training dataset, the training dataset comprises a plurality of training data pairs, and the training data pair comprises an original image, an image expansion description text, a random mask, a masked image obtained by masking the original image based on the random mask, and a cropped image obtained through cropping based on the original image and the random mask; and
obtaining a predicted noise corresponding to the padded image, which is output by the target model, and performing an image expansion operation on the image to be processed based on the predicted noise.

2. The method according to claim 1, further comprising: before inputting the padded image and the image expansion text to the preset target model,
obtaining an original dataset, wherein the original dataset comprises original data groups, and the original data group comprises an original image, an image expansion description text, and a random mask;
performing data processing on a plurality of original data groups in the original dataset to obtain a training dataset; and
iteratively training a preset model to be trained through the training dataset to obtain the target model.

3. The method according to claim 2, wherein performing data processing on the plurality of original data groups in the original dataset to obtain the training dataset comprises:
determining a target region in the original image that matches the random mask, and performing a masking operation on a region in the original image other than the target region to obtain a masked image;
performing a cropping operation on the target region to obtain a cropped image;
determining the original image, the random mask, the image expansion description text, the cropped image, and the masked image as a training data pair; and
constructing the training dataset based on a plurality of training data pairs corresponding to the plurality of original data groups.

4. The method according to claim 2, wherein iteratively training the preset model to be trained through the training dataset to obtain the target model comprises:
determining a text feature vector corresponding to the image expansion description text, and determining an image feature vector corresponding to the cropped image;
determining a first latent space vector corresponding to the original image, and determining a second latent space vector corresponding to the masked image;
determining the text feature vector, the image feature vector, the first latent space vector, the second latent space vector, and the random mask as a feature data group; and
performing an iterative training operation on the model to be trained based on a plurality of feature data groups corresponding to the training dataset until the model to be trained satisfies a preset convergence condition, so as to obtain the trained target model.

5. The method according to claim 4, further comprising: after determining the text feature vector corresponding to the image expansion description text, and determining the image feature vector corresponding to the cropped image,
calculating cross-attention information based on the text feature vector and the image feature vector; and
determining the cross-attention information, the first latent space vector, the second latent space vector, and the random mask as a training data group.

6. The method according to claim 5, wherein performing the iterative training operation on the model to be trained based on the plurality of feature data groups corresponding to the training dataset until the model to be trained satisfies the preset convergence condition, so as to obtain the trained target model comprises:
inputting the first latent space vector, the second latent space vector, the cross-attention information, the random mask, and the preset noise to the model to be trained;
obtaining predicted noise information corresponding to the masked image, which is output by the model to be trained;
determining a loss value corresponding to the model to be trained based on the predicted noise information and the preset noise;
determining, based on the loss value, whether the model to be trained satisfies the preset convergence condition; and
in response to the model to be trained satisfying the preset convergence condition, determining the current model to be trained as the target model,
in response to the model to be trained not satisfying the preset convergence condition, performing an adjustment operation on a model parameter corresponding to the model to be trained based on the loss value, using the adjusted model to be trained as the current model to be trained, and returning to the step of inputting the first latent space vector, the second latent space vector, the cross-attention information, the random mask, and the preset noise to the model to be trained, until the model to be trained satisfies the convergence condition, so as to obtain the target model.

7. The method according to claim 6, wherein determining, based on the loss value, whether the model to be trained satisfies the preset convergence condition comprises:
determining whether the loss value is less than a preset loss value threshold; or
calculating a difference between a loss value corresponding to a current iteration of training and a loss value corresponding to a previous iteration of training; and determining whether the difference is less than a preset difference threshold.

8. The method according to claim 4, wherein determining the image feature vector corresponding to the cropped image comprises:
extracting the image feature vector corresponding to the cropped image based on a preset multi-modal pre-trained neural network and/or a preset large vision model.

9. The method according to claim 1, wherein performing the image expansion operation on the image to be processed based on the predicted noise comprises:
performing a denoising operation on the padded image based on the predicted noise, and determining the denoised padded image as a target image after image expansion.

10. An electronic device, comprising a processor and a memory, wherein
the memory stores computer-executable instructions; and
the processor executes the computer-executable instructions stored in the memory to cause the processor to:
obtain an image to be processed and an image expansion text;
perform a padding operation on the image to be processed based on a preset background to obtain a padded image, wherein a display size of the preset background is greater than a display size of the image to be processed;
input the padded image and the image expansion text to a preset target model, wherein the target model is obtained after a preset model to be trained is iteratively trained based on a preset training dataset, the training dataset comprises a plurality of training data pairs, and the training data pair comprises an original image, an image expansion description text, a random mask, a masked image obtained by masking the original image based on the random mask, and a cropped image obtained through cropping based on the original image and the random mask; and
obtain a predicted noise corresponding to the padded image, which is output by the target model, and perform an image expansion operation on the image to be processed based on the predicted noise.

11. The electronic device according to claim 10, wherein the computer-executable instructions further cause the processor to: before inputting the padded image and the image expansion text to the preset target model,
obtain an original dataset, wherein the original dataset comprises original data groups, and the original data group comprises an original image, an image expansion description text, and a random mask;
perform data processing on a plurality of original data groups in the original dataset to obtain a training dataset; and
iteratively train a preset model to be trained through the training dataset to obtain the target model.

12. The electronic device according to claim 11, wherein the computer-executable instructions causing the processor to perform data processing on the plurality of original data groups in the original dataset to obtain the training dataset cause the processor to:
determine a target region in the original image that matches the random mask, and perform a masking operation on a region in the original image other than the target region to obtain a masked image;
perform a cropping operation on the target region to obtain a cropped image;
determine the original image, the random mask, the image expansion description text, the cropped image, and the masked image as a training data pair; and
construct the training dataset based on a plurality of training data pairs corresponding to the plurality of original data groups.

13. The electronic device according to claim 11, wherein the computer-executable instructions causing the processor to iteratively train the preset model to be trained through the training dataset to obtain the target model cause the processor to:
determine a text feature vector corresponding to the image expansion description text, and determine an image feature vector corresponding to the cropped image;
determine a first latent space vector corresponding to the original image, and determine a second latent space vector corresponding to the masked image;
determine the text feature vector, the image feature vector, the first latent space vector, the second latent space vector, and the random mask as a feature data group; and
perform an iterative training operation on the model to be trained based on a plurality of feature data groups corresponding to the training dataset until the model to be trained satisfies a preset convergence condition, so as to obtain the trained target model.

14. The electronic device according to claim 13, wherein the computer-executable instructions further cause the processor to: after determining the text feature vector corresponding to the image expansion description text, and determining the image feature vector corresponding to the cropped image,
calculate cross-attention information based on the text feature vector and the image feature vector; and
determine the cross-attention information, the first latent space vector, the second latent space vector, and the random mask as a training data group.

15. The electronic device according to claim 14, wherein the computer-executable instructions causing the processor to perform the iterative training operation on the model to be trained based on the plurality of feature data groups corresponding to the training dataset until the model to be trained satisfies the preset convergence condition, so as to obtain the trained target model cause the processor to:
input the first latent space vector, the second latent space vector, the cross-attention information, the random mask, and the preset noise to the model to be trained;
obtain predicted noise information corresponding to the masked image, which is output by the model to be trained;
determine a loss value corresponding to the model to be trained based on the predicted noise information and the preset noise;
determine, based on the loss value, whether the model to be trained satisfies the preset convergence condition; and
in response to the model to be trained satisfying the preset convergence condition, determine the current model to be trained as the target model,
in response to the model to be trained not satisfying the preset convergence condition, perform an adjustment operation on a model parameter corresponding to the model to be trained based on the loss value, use the adjusted model to be trained as the current model to be trained, and return to the step of inputting the first latent space vector, the second latent space vector, the cross-attention information, the random mask, and the preset noise to the model to be trained, until the model to be trained satisfies the convergence condition, so as to obtain the target model.

16. The electronic device according to claim 15, wherein the computer-executable instructions causing the processor to determine, based on the loss value, whether the model to be trained satisfies the preset convergence condition cause the processor to:
determine whether the loss value is less than a preset loss value threshold; or
calculate a difference between a loss value corresponding to a current iteration of training and a loss value corresponding to a previous iteration of training; and determine whether the difference is less than a preset difference threshold.

17. The electronic device according to claim 13, wherein the computer-executable instructions causing the processor to determine the image feature vector corresponding to the cropped image cause the processor to:
extract the image feature vector corresponding to the cropped image based on a preset multi-modal pre-trained neural network and/or a preset large vision model.

18. The electronic device according to claim 10, wherein the computer-executable instructions causing the processor to perform the image expansion operation on the image to be processed based on the predicted noise cause the processor to:
perform a denoising operation on the padded image based on the predicted noise, and determine the denoised padded image as a target image after image expansion.

19. A non-transitory computer-readable storage medium storing computer-executable instructions that, when executed by a processor, cause the processor to:
obtain an image to be processed and an image expansion text;
perform a padding operation on the image to be processed based on a preset background to obtain a padded image, wherein a display size of the preset background is greater than a display size of the image to be processed;
input the padded image and the image expansion text to a preset target model, wherein the target model is obtained after a preset model to be trained is iteratively trained based on a preset training dataset, the training dataset comprises a plurality of training data pairs, and the training data pair comprises an original image, an image expansion description text, a random mask, a masked image obtained by masking the original image based on the random mask, and a cropped image obtained through cropping based on the original image and the random mask; and
obtain a predicted noise corresponding to the padded image, which is output by the target model, and perform an image expansion operation on the image to be processed based on the predicted noise.

20. The non-transitory computer-readable storage medium according to claim 19, wherein the computer-executable instructions further cause the processor to: before inputting the padded image and the image expansion text to the preset target model,
obtain an original dataset, wherein the original dataset comprises original data groups, and the original data group comprises an original image, an image expansion description text, and a random mask;
perform data processing on a plurality of original data groups in the original dataset to obtain a training dataset; and
iteratively train a preset model to be trained through the training dataset to obtain the target model.
